(19) United States
(12) Patent Application Publication
(10) Pub. No.: US 2015/0254760 A1
(43) Pub. Date: Sep. 10, 2015

(54) ELECTRONIC RENTAL LOCKER SYSTEM

(71) Applicant: Clifford N. Pepper, San Diego, CA (US)

(72) Inventor: Clifford N. Pepper, San Diego, CA (US)

(21) Appl. No.: 14/615,402

(22) Filed: Feb. 5, 2015

Related U.S. Application Data
(60) Provisional application No. 61/948,444, filed on Mar. 5, 2014.

(51) Int. Cl. G06Q 30/06; A47F 10/02; A47B 81/00; G06Q 10/02; G06Q 20/28

(52) U.S. Cl. CPC G06Q 30/0645; G06Q 10/02; G06Q 20/28; A47B 81/00; A47F 10/02

(57) ABSTRACT

The present invention provides an electronic rental locker system, comprising: a housing unit; a plurality of locker compartments within the housing unit, each locker compartment having a door and a door lock; a payment processing system configured to receive payment by a user for a locker compartment; and a reservation and subscription server. The server is configured to: receive a request from a user to rent a locker compartment; access a database to determine whether the user has a reservation or subscription to rent the locker compartment and whether the user has previously paid to rent the locker compartment; allowing the user to open the locker compartment if the user has previously paid to rent the locker compartment; and requesting payment from the user if the has previously not paid to rent the locker compartment.

### RELATED APPLICATION DATA

The present application is related to and claims the benefit of: commonly-assigned and co-pending U.S. Provisional Application Ser. No. 61/948,444 entitled ELECTRONIC RENTAL LOCKERS WITH SUBSCRIPTION SERVICE and filed on Mar. 5, 2014; and commonly-assigned and co-pending U.S. Provisional Application Ser. No. 62/072,407 entitled ELECTRONIC RENTAL LOCKERS and filed on Oct. 29, 2014, which applications are incorporated herein by reference in their entireties.

### TECHNICAL FIELD

The present invention relates generally to rental lockers and, in particular, to electronic rental locker systems provided with optional subscription services.

### BACKGROUND ART

Consumers often go to various entertainment venues such as bars, nightclubs and restaurants and other public places, with their coats, hats, purses, mobile cellular phones, and many other accessories. While these items provide protection from the elements or are carried along for convenience, they are often inconvenient to manage once the consumer has arrived at their destination. To mingle, eat, or dance, consumers often set these items down. However, when the consumer comes back to retrieve the items, they may have been lost or stolen. If the consumer forgets to retrieve their items, they could call the venue the next day to ask if the items are in the lost and found. This is inconvenient for both the consumer who might lose their valuable items and for the establishment that has to deal with unhappy customers and a collection of unclaimed items. If the venue has a hat or coat check, they often don't accept valuable items such as purses or mobile cellular phones. Furthermore, the venue typically has to pay for an attendant to staff the hat or coat check area. Rental lockers may be used for storing personal items; however, empty lockers may not be available due to high demand during peak hours, especially in popular entertainment venues or busy public places. Thus, there remains a need for improved storage of personal items in various entertainment venues and other public places.

### SUMMARY OF THE INVENTION

The present invention provides an electronic rental locker system, comprising: a housing unit; a plurality of locker compartments within the housing unit, each locker compartment having a door and a door lock; a payment processing system configured to receive payment by a user for a locker compartment; and a reservation and subscription server. The server is configured to: receive a request from a user to rent a locker compartment; access a database to determine whether the user has a reservation or subscription to rent the locker compartment and whether the user has previously paid to rent the locker compartment; allowing the user to open the locker compartment if the user has previously paid to rent the locker compartment; and requesting payment from the user if the has previously not paid to rent the locker compartment.

The present invention also provides a method for providing a locker compartment to rent by a user, comprising: receiving a request at a server by a user to rent a locker compartment, the locker compartment being one of a plurality of locker compartments in a housing; accessing a database to determine if the user has a reservation to rent the locker compartment; if the user has a reservation to use the locker compartment, accessing the database to determine if the user has pre-paid to rent the locker compartment; if the user has pre-paid to rent the locker, unlocking a lock on a door of the locker compartment and allowing the user to access the locker compartment; and if the user has not pre-paid to rent the locker, requesting payment from the user, receiving payment from the user, and allowing the user to access the locker compartment. If the user does not have a reservation to use the locker, accessing the database to determine if the user has a pre-paid subscription to rent the locker compartment; if the user has a pre-paid subscription to rent the locker, unlocking a lock on a door of the locker compartment and allowing the user to access the locker compartment; if the user does not have a reservation and does not have a pre-paid subscription, requesting payment from the user, receiving payment from the user and allowing the user to access the locker compartment.

The present invention further provides another method for providing a locker compartment to rent by a user. The method comprises: downloading an app onto a user's electronic device; receiving input from the user, the input including identification and payment information; storing the input information; opening the app on the user's electronic device; presenting the user with locations of locker compartments; receiving an indication from the user of a location of a locker that the user wants to rent; receiving an indication from the user the number of rentals that the user wants to purchase; and receiving authorization from the user to apply the previously input payment information to the purchase.

### BRIEF DESCRIPTION OF THE DRAWINGS

FIG. 1 is a front perspective schematic view of an embodiment of a rental locker system of the present invention with one of the locker compartments in the open position;

FIG. 2 is a block diagram of a reservation and subscription system for use with the rental locker system of FIG. 1;

FIG. 3 is a flow chart of a method of using the rental locker system of FIG. 1;

FIG. 4 is an embodiment of a display screen that may be incorporated into the rental locker system of FIG. 1;

FIG. 5 is a flow chart of another method of using the rental locker system of FIG. 1;

FIGS. 6A and 6B illustrate perspective and cross-sectional views, respectively, of another configuration of an electronic locker system of the present invention; and

FIG. 7 illustrates a perspective view of still another configuration of an electronic locker system of the present invention.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

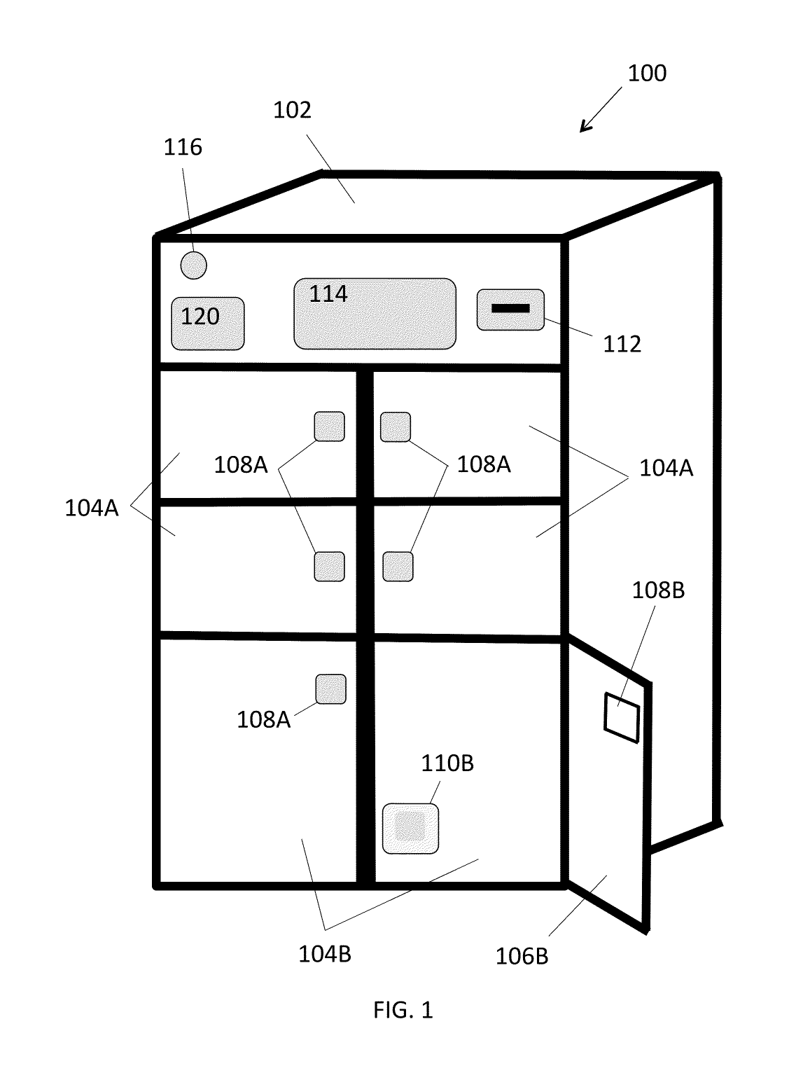

Referring to FIG. 1, the present invention provides a electronic rental locker system 100 for storing personal items in various entertainment venues and other public places. The locker system 100 may include a housing unit 102 containing a plurality of small locker compartments 104A and large locker compartments 104B (collectively referred to herein as locker compartments 104) securely attached or coupled together. In embodiments, the housing unit 102 has a top side, a bottom side, a back side, and a front side; and may be made of any suitable material known in the art. For example, the housing unit 102 may include one or more metal frames and a sheet metal covering securely fastened together by a fastening means such as brackets, bolts and nuts, rivets, screws and the like. The housing unit 102 may be of any suitable size. For example, the housing unit 102 may be from about 1 to about 6 feet wide, from about 1 to about 4 feet deep, and from about 3 to about 8 feet high; or from about 2 to about 5 feet wide, from about 1 to about 3 feet deep, and from about 4 to about 7 feet high; or from about 3 to about 4 feet wide, from about 1 to about 2 feet deep, and from about 5 to about 6 feet high. It will be appreciated that the housing unit 102 may be of any other size to accommodate the needs of different venues.

The housing unit 102 may be divided into a plurality of locker compartments 104, which may be present in a series of columns and/or rows present in the housing unit. In embodiments, the housing unit 102 may include from about 1 to about 6 columns, or from about 2 to about 5 columns, or from about 3 to about 4 columns; and from about 1 to about 12 rows, or from about 2 to about 11 rows, or from about 4 to about 8 rows, or about 6 rows. In embodiments, each column and/or row may contain from about 1 to about 6 locker compartments 104, or from about 2 to about 5 locker compartments, or from about 3 to about 4 locker compartments 104. It will be appreciated that the housing unit 102 may have any other number of locker compartments 104, and in any other configuration to accommodate the needs of different venues.

The locker compartments 104 in the housing unit 102 may be the same or different sizes within the housing unit 102, and may be of any suitable size and shape. For example, in FIG. 1 four of the locker compartments 104A are of a small size and two of the locker compartments 104B are of a larger size. By way of further example, each of the locker compartments 104 may be from about 1 to about 6 feet wide, from about 1 to about 4 feet deep, and from about 1 to about 8 feet high, or from about 1 to about 3 feet wide, from about 1 to about 3 feet deep, and from about 1 to about 6 feet high, or from about 1 to about 3 feet wide, from about 1 to about 2 feet deep, and from about 1 to about 4 feet high, or from about 1 to about 2 feet wide, from about 1 to about 1.5 feet deep, and from about 1 to about 2 feet high, or from about 1 foot wide, from about 1 to about 1 foot deep, and from about 1 foot high, and may be substantially square and/or substantially rectangular in shape. Each of the columns and/or rows may comprise the plurality of locker compartments 104 securely attached or coupled together.

Using one of the larger locker compartments 104B as an example, each of the locker compartments 104 includes an outer wall, located on the front side of the housing unit, with a door 106B (shown in the open position in the FIG.) for providing access into the compartment 104B. The door 106B may be hingedly attached or coupled to the locker compartment 104B. A lock 108B may be provided for selectively locking the door 106B in a closed position. The lock 108B may be mechanically and/or electronically coupled to the door 106B to be locked, mechanically with a key or a combination number or other mechanical locking means, or electronically with a magnetic swipe card or with an unique personal identification number (PIN) or other passcode for accessing and securing the locker compartment 106B or other electronic means.

The electronic rental locker system 100 may also include a phone charging feature. For example, one or more of the locker compartments 104 in the housing unit 102 may include its own charger port 110B (seen in the back wall of the locker compartment 104B) for charging a user's mobile cellular phone or other electronic device while the device is stored in the compartment 104. In embodiments, the charger port 110B may include one or more of a 30-pin dock connector for an iPhone 4 phone, an 8-pin lightning connector for an iPhone 5 or later phone, a mini- or micro-USB connector for an Android phone, or any other current or future charging connector.

The electronic rental locker system 100 may also include a payment process system 112 for payment of a locker compartment 104 by a user, for example, by cash and/or by a credit or debit card. For example, a device such as an automated teller machine (ATM) may be adopted for use.

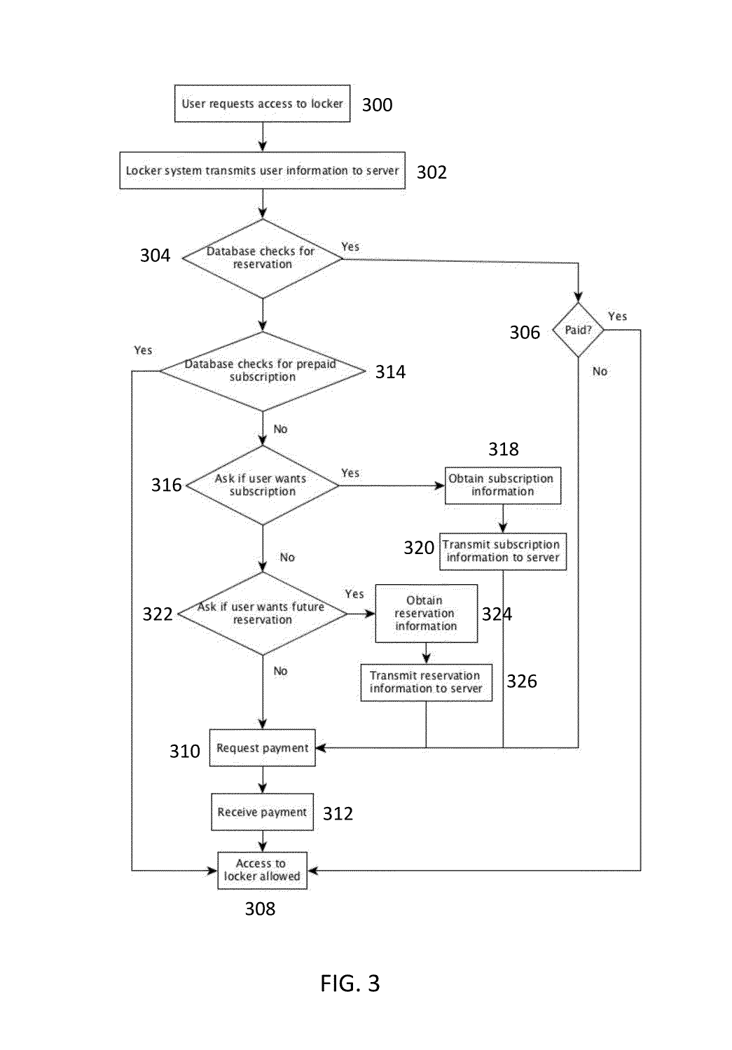

The electronic rental locker system 100 may also include a processing unit 120 configured to supervise the payment process system 112, the locks 108A, 108B (collectively referred to as 108), a display and user input device 114, and also provide an interface with a reservation locker process server 300 (FIG. 3), either directly or through a network 10.

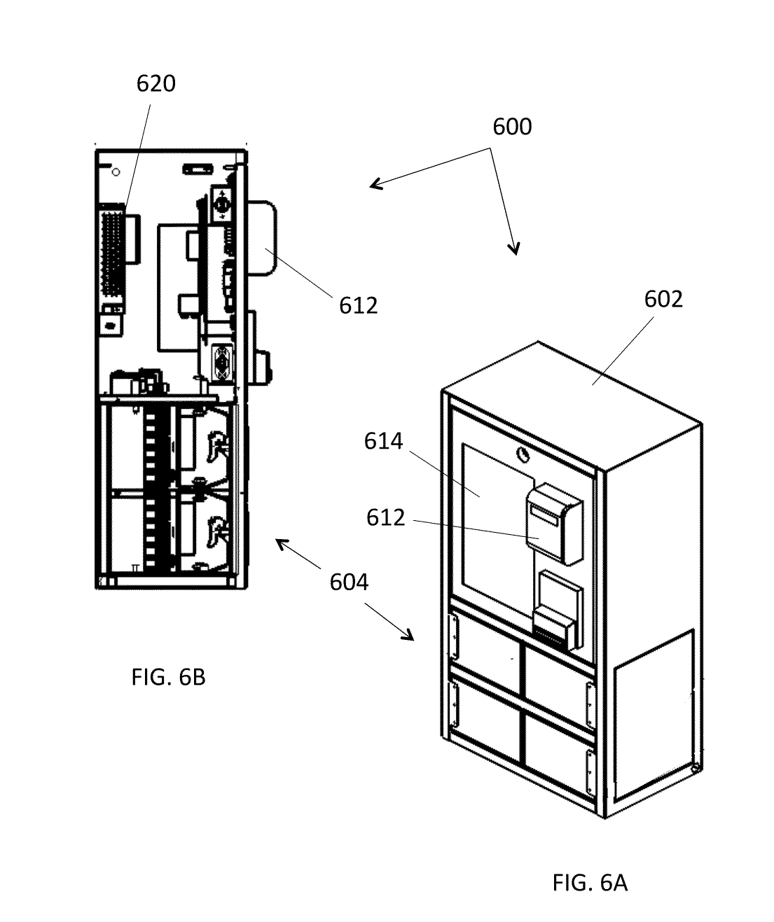

FIG. 6A illustrates a perspective view, and FIG. 6B illustrates a cross-sectional view, of another configuration of an electronic locker system 600 of the present invention. The system 600 includes a set of locker compartments 640, a payment process system 612, a display and user input device 614, and a processing unit 620 all within a housing 602.

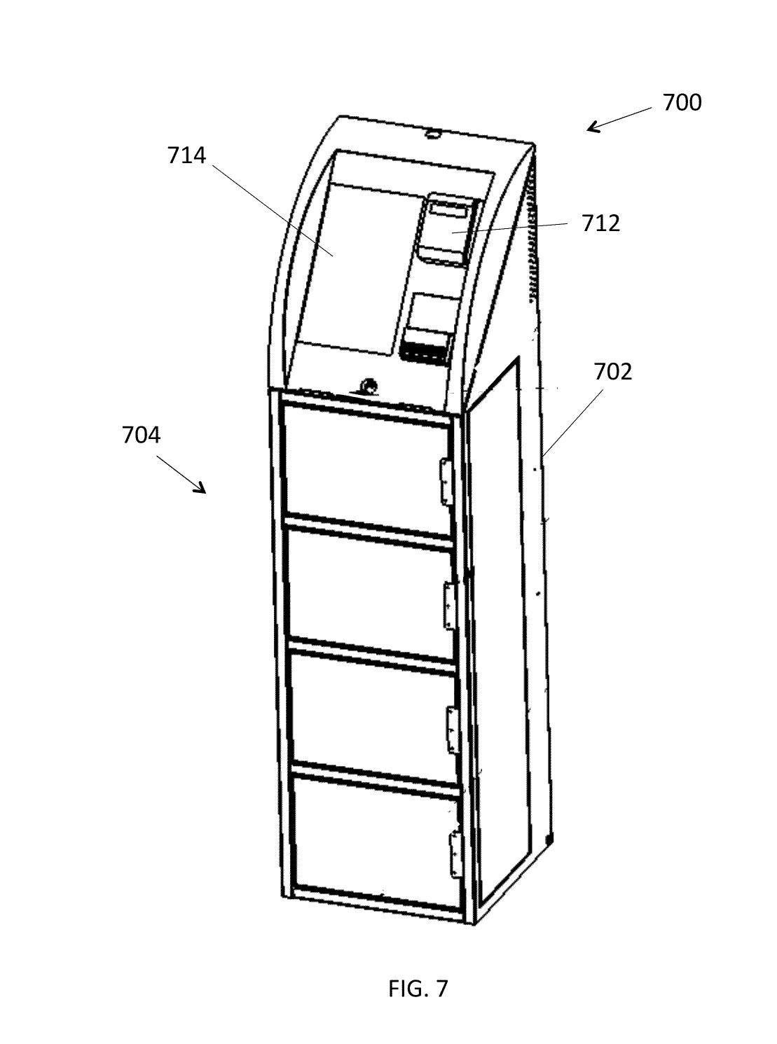

FIG. 7 illustrates a perspective view of still another configuration of an electronic locker system 700 of the present invention, within an ATM machine-like housing 702. The system 700 includes a set of locker compartments 740, a payment process system 712, and a display and user input device 714. Other components are not shown in FIG. 7.

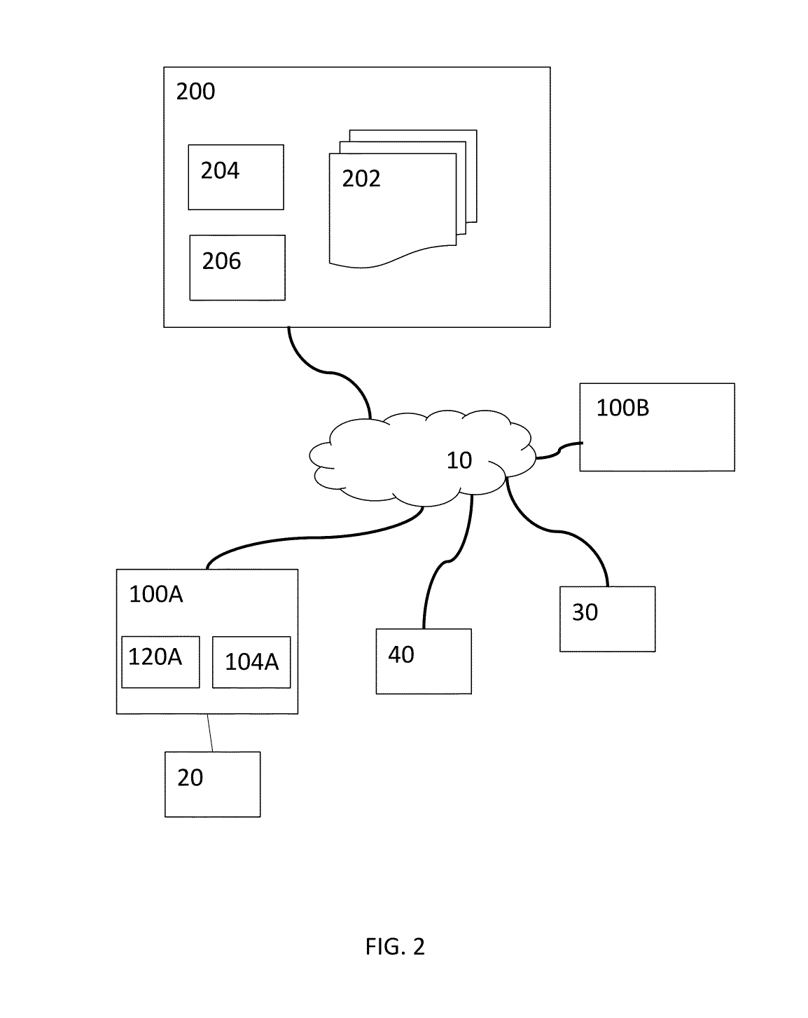

Referring to FIG. 2 and the flow chart of FIG. 3, the electronic rental locker system 100 may also include a subscription and reservation locker process server 200 for subscribing or for reserving a locker by a user in advance by cash and/or by a credit or debit card. The server 200 may be coupled to one or more locker systems 100A, 100B through a network 10, such as the internet or a local network. The server 300 may include a database 202, memory 204 configured to store instructions, and a processor 206 coupled to the database 202 and memory 204 for executing the instructions stored in the memory 304. Alternatively, the server 200 be incorporated into the locker housing 102 with the processing unit 120 coinciding or supplementing the processor 206.

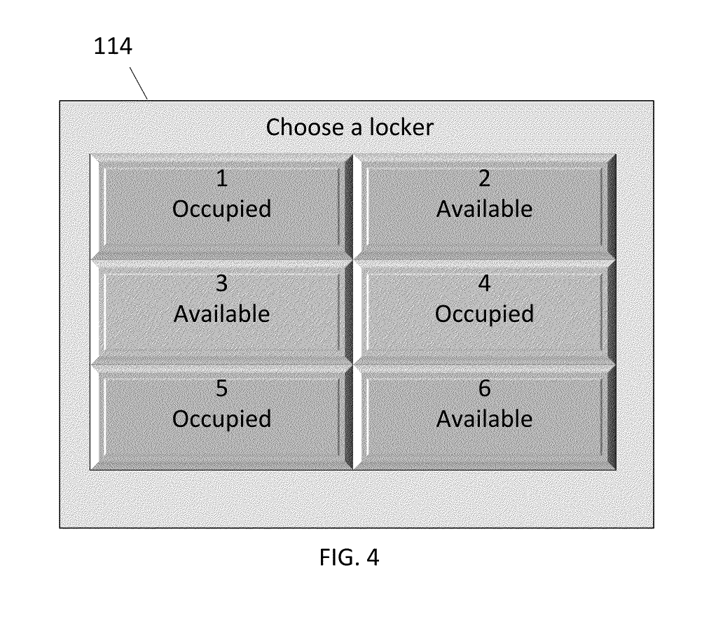

When a user 20 wishes to rent a locker compartment 104 in the locker housing 102 (step 300), the user selects an available locker from the display and input device 114 (FIG. 4). The display and input device 114 may be a touch screen that both displays information and receives user input or may be a display and separate input device, such as a keypad. The user 20 may also enter personal information, such as a user ID and password or PIN, if he or she is a repeat customer. The information is transmitted to the database 202 in the server 200 (step 302), such as through the processing unit 120A and the network 10. Based on instructions stored in the memory 204, the processor 206 accesses the database 202 to determine if the user 20 has a reservation for the locker compartment 104 (step 304). If so, a determination is made as to whether the user 20 has pre-paid for the reservation (set 306). If so, the server 200 transmits instructions back to the locker housing to allow the user 20 to access the locker compartment 104 (step 308). If the reservation was not pre-paid, the user 20 will be requested to pay for the rental (step 310). The user 20 may provide a credit or debit card or cash to the payment processing system 112 (step 312), the lock 108 on the door 106 will unlock, and the user 20 will then be able to access the locker compartment 104 (step 308).

If the user 20 does not have a reservation, the processor 206 accesses the database 202 to determine if the user 20 has a pre-paid subscription for the locker compartment 104 (step 314). If so, the user 20 is granted access to the locker compartment 104.

If the user 20 does not have either a reservation or a subscription, the user 20 may be asked if he or she wants to purchase a subscription (step 316). If so, the user 20 may enter information about the locker compartment he or she desires, how often and when he or she will use it, and payment information (step 318). That information is then transmitted to the server 300 (step 420) to be stored in the database 202 and accessed when the user 20 next uses the locker compartment 104.

The user 20 may also be asked if he or she would like to make any future reservations (step 322). If so, the user 20 may enter information about the locker compartment he or she desires, how often and when he or she will use it, and payment information (step 324). That information is then transmitted to the server 200 (step 326) to be stored in the database 202 and accessed when the user 20 next uses the locker compartment 104.

If the user 20 does not have a reservation or subscription and does not want to subscribe or make a reservation, the user 20 will be asked to pay for the rental (step 310). After the user provides a credit or debit card or cash to the payment processing system 112 (step 312), the user 20 will then be able to access the locker compartment 104 (step 308).

Access to the locker compartment 104 may be provided by electronically unlocking the lock 108 or providing the user 20 with an electronic access code if the lock 108 is an electronic lock or by providing the user 20 with a mechanical code if the lock 108 is a mechanic lock. The user 20 may later access the locker compartment 104 to retrieve items by logging in through the display and input device 114 and requesting access if the lock 108 or entering the access code if is an electronic lock or by using the mechanical code if the lock 108 is a mechanic lock.

In an alternative embodiment, access to the locker compartment 104 may be provided to the user 20 before he or she pays. When the user 20 later returns to retrieve items from the locker compartment 104, the locker system 100 may request a payment that is based on the length of time the user 20 rented the locker compartment 104.

The database 202 may also include information about the user's 20 preference for locker size and shape, length of duration of the subscription or reservation, and venue information, such as a locker system 100A at one venue or a locker system 100B at a different venue.

The user 20 may use the reservation or subscription service to store items in the locker compartment 104A on a recurring basis, for example, from an hour-to-hour, day-to-day, week-to-week, or on a month-to-month basis. The user 20 may also rent the locker compartment 104A on a per-rental basis, either by paying for a one-time, single rental or by paying for a fixed number of rentals in advance. In the latter instance, the user 20 may log into the server 200 to access a locker compartment 104A. The database 202 may keep track of the number of rentals the user 20 has made and notify the user 20 when the number of remaining rentals is running low.

The electronic rental locker system 100 may be operated in any venue, including entertainment venues such as bars, nightclubs, restaurants and the like, and including public places such as commuter car pick-up/drop-off stations, bus stations, train stations, airports and the like.

Further uses of the electronic rental locker system 100 of the present invention may include allowing a third party to access a locker compartment rented by a user. For example, if a person 20 (FIG. 2) is selling an item, such as through Craigslist® or EBAY®, to another person 30, the seller 20 may rent a locker compartment 104A in a locker system 100A and lock the item in the locker compartment 104A. The seller may then notify the buyer 30 and provide the buyer 30 with the location and a passcode to access the locker compartment 104A at his or her convenience. A similar procedure may also be used when a person 20 is renting an item to another person 30. Or, if a person 30 accidentally leaves an item at a location, such as leaving a coat in a restaurant, an employee of the restaurant could place the coat in a locker compartment 104A and let the person 30 know the location and passcode so he or she could pick up the coat at a later time. Still further, if an individual 20 rents his or her house or apartment to another 30 through a service such as Airbnb®, the individual 20 may rent a locker compartment 104A and leave the key to the house or apartment in the locker compartment 104A. The individual 20 may then notify the renter 30 of the location of the key and the passcode to access the locker compartment 104A.

The locker system 100 may also be used for package delivery if, for example, the package cannot be delivered directly to the recipient or the recipient is unable to immediately pick up the package. The package delivery service may place the package in a locker compartment 104A and let the recipient 30 know the location and passcode to open the locker compartment 104A. The electronic locker system 100 may also be used for the reverse procedure: the sender 20 may leave a package in a locker compartment 104A and notify a package delivery service 40 of its location and passcode. The package delivery service 40 may later pick up the package from the locker compartment 104A and deliver it to its intended recipient. In both situations, the package is secure until it can be picked up by the recipient or the package delivery service 40.

A regular user may also download, install, and use a smartphone app to pay for rental, control access to a locker compartment, make reservations, find the nearest locker system, manage a subscription, and send access information to others (as described above).

In embodiments, the display 114 (FIGS. 1, 4) may be used to provide information to users, accept access information from users, and display advertising. For example, FIG. 4 illustrates one possible display that may be presented on the display screen 114. As illustrated, a user may be presented with rows and columns representing the physical rows and columns of the locker compartments 104 in a particular locker system 100. The user may easily determine which locker compartments 104 are available and which are occupied. In some embodiments, the representations of the available and occupied locker compartments 104 may be different colors, such as green and red, respectively. The user may reserve or rent an available locker compartment 104 by touching or otherwise selecting its representation. A touch screen 114 may also be used by a customer of a facility to order food, drinks, or other items. For example, a fan at a sports event may place an order for food, drinks, or a souvenir through a locker system 100 and then return to his or her seat. The order would be sent directly to the appropriate staff (food vendor, drink vendor, or souvenir vendor) who would process the order and deliver the items to a locker compartment. When the order is fulfilled, a message may be sent to the fan, such as a text message to his or her phone, who would open the locker compartment and retrieve the items. The display screen 114 may also indicate whether a device is being charged by the charger 110 within a selected locker compartment 104 and, if so, the charging status of the device. The charge indicator may be presented as words or as an icon, such as those presented on many cell phones.

In some embodiments, the locker system 100 may also be provided with a camera 116 adjacent the display screen 114. The camera 116 may be coupled to the internet and used to take photos, such as of the user, to be uploaded and posted to various social media.

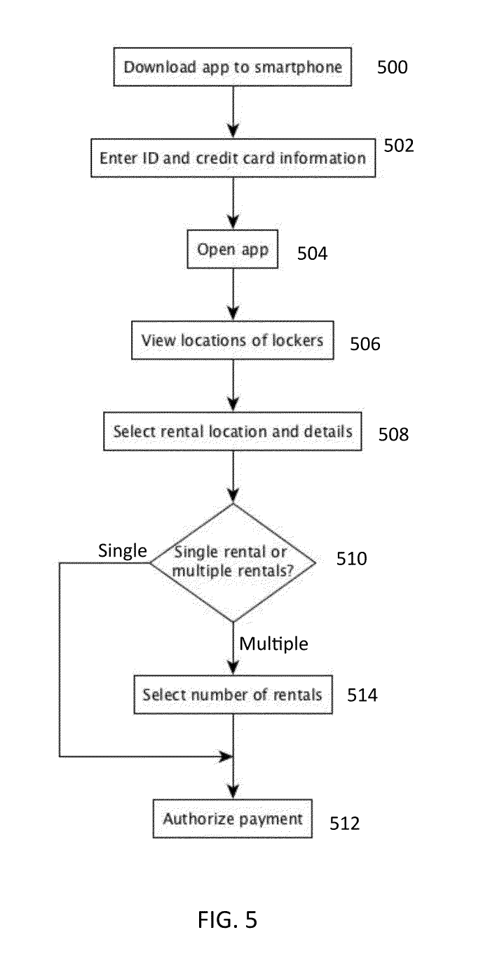

The flow chart of FIG. 5 illustrates another method that may be used with the locker system 100 of the present invention. The user or customer 20 may download an app onto his or her electronic device, such as a smartphone (step 500), and then enters identification and credit card or other payment information (step 502), which is stored by the app on the smartphone or sent to the server 200. When the user 20 wants to rent a locker, the user opens the app (step 504) on the smartphone and views a map indicating the locations of locker systems 100 or views a listing of locations (step 506). The display may be based on the current location of the user 20 or may be based on other criteria, such as a zip code, that is entered by the user 20. From the map or list, the user 20 may select a location for his or her rental (step 508). The user 20 may also choose to rent a locker compartment 104 one time or rent the locker compartment 104 multiple times (step 510). If the user 20 chooses a single rental, the user 20 may enter the size of the locker compartment 104, the date, time, and length of the rental. After all of the information has been entered, the user 20 may authorize payment from the payment information stored by the app (step 512).

If the user 20 chooses to rent a locker compartment 104 multiple times, the user 20 may select the number of rentals (step 514). The user 20 may simply enter a number or select a number from an displayed list, such as in multiples of five. The user 20 may also designate that all rentals will be at a single selected location or at multiple selected locations. The user 20 may also designate the location of the first rental and leave the locations of the remaining rentals for a later designation. Again, after all of the information has been entered, the user 20 may authorize payment from the payment information stored by the app (step 512). When renting multiple lockers at one time, the user 20 may be offered a discount, such as 12 rentals for the price of 10.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An electronic rental locker system, comprising:
a housing unit;
a plurality of locker compartments within the housing unit, each locker compartment having a door and a door lock;
a payment processing system configured to receive payment by a user for a locker compartment; and
a reservation and subscription server configured to:
receive a request from a user to rent a locker compartment;
access a database to determine whether the user has a reservation or subscription to rent the locker compartment and whether the user has previously paid to rent the locker compartment;
allowing the user to open the locker compartment if the user has previously paid to rent the locker compartment; and
requesting payment from the user if the has previously not paid to rent the locker compartment.

2. The electronic rental locker system of claim 1, wherein the reservation and subscription server comprises a remote server coupled to the housing unit through a network.

3. The electronic rental locker system of claim 1, wherein the reservation and subscription server comprises a server within the housing unit.

4. The electronic rental locker system of claim 1, further comprising a charger port in at least one of the plurality of locker compartments.

5. The electronic rental locker system of claim 1, further comprising a display and input device configured to display information to, and receive information from, the user.

6. The electronic rental locker system of claim 5, wherein the display and input device comprise a touch screen.

7. The electronic rental locker system of claim 5, wherein the display and input device comprise a display screen and a keypad.

8. A method for providing a locker compartment to rent by a user, comprising:
receiving a request at a server by a user to rent a locker compartment, the locker compartment being one of a plurality of locker compartments in a housing;
accessing a database to determine if the user has a reservation to rent the locker compartment;
if the user has a reservation to use the locker compartment, accessing the database to determine if the user has pre-paid to rent the locker compartment;
if the user has pre-paid to rent the locker, unlocking a lock on a door of the locker compartment and allowing the user to access the locker compartment; and
if the user has not pre-paid to rent the locker, requesting payment from the user, receiving payment from the user, and allowing the user to access the locker compartment;
if the user does not have a reservation to use the locker, accessing the database to determine if the user has a pre-paid subscription to rent the locker compartment;
if the user has a pre-paid subscription to rent the locker, allowing the user to access the locker compartment;
if the user does not have a reservation and does not have a pre-paid subscription, requesting payment from the user, receiving payment from the user and allowing the user to access the locker compartment.

9. The method of claim 8, wherein the server and database are coupled to the housing through a network.

10. The method of claim 8, wherein the server and database are incorporated into the housing.

11. A method for providing a locker compartment to rent by a user, comprising:
offering a user a plurality of locker compartments to rent;
receiving user identification information and an indication of a selected one of the plurality of locker compartments the user wants to rent;
transmitting the user identification information and the indication to a reservation and subscription server for a determination as to whether the user has pre-paid to rent the selected locker compartment;
receiving from the reservation and subscription server the determination;
granting the user access to the selected locker compartment if the determination was that the user had pre-paid to rent the locker compartment;
requesting payment from the user if the determination was that the user had not previously paid to rent the locker compartment;
receiving payment from the user; and
granting the user access to the selected locker compartment after receiving payment from the user.

12. The method of claim 11, further comprising, if the determination was that the user had not previously paid to rent the locker compartment:
asking the user if the user wants to make a reservation to rent a locker compartment in the future;
if the user wants to make a reservation to rent a locker compartment, asking the user for a rental date;
asking the user if the user wants to pre-pay for the reservation;
requesting and receiving payment from the user if the user wants to pre-pay for the reservation; and
transmitting the user identification information, rental date, and pre-payment information to the reservation and subscription server for storing and later access.

13. The method of claim 11, further comprising, if the determination was that the user had not previously paid to rent the locker compartment:
asking the user if the user wants to subscribe to rent a locker compartment at a plurality of times in the future;
if the user wants to subscribe to rent a locker compartment, asking the user for the number of times the user wants to rent the locker compartment in the future;
requesting and receiving pre-payment from the user for the subscription; and
transmitting the user identification information, the number of rental times, and pre-payment information to the reservation and subscription server for storing and later access.

14. The method of claim 11, further comprising,
after granting the user access to the selected locker compartment, the user placing an item in the selected locker compartment; and
giving access information to a third party to allow the third party to access the selected locker compartment and retrieve the item.

15. The method of claim 11, further comprising:
offering a user a plurality of locker compartments to rent through a display screen; and
receiving user identification information and an indication of a selected one of the plurality of locker compartments the user wants to rent though a keypad.

16. The method of claim 11, further comprising offering a user a plurality of locker compartments to rent and receiving user identification information and an indication of a selected one of the plurality of locker compartments the user wants to rent through a touch screen.

17. A method for providing a locker compartment to rent by a user, comprising:
downloading an app onto a user's electronic device;
receiving input from the user, the input including identification and payment information;
storing the input information;
opening the app on the user's electronic device;
presenting the user with locations of locker compartments;
receiving an indication from the user of a location of a locker that the user wants to rent;
receiving an indication from the user the number of rentals that the user wants to purchase; and
receiving authorization from the user to apply the previously input payment information to the purchase.

18. The method of claim 17, wherein presenting the user with locations of locker compartments comprises displaying a map on the electronic device identifying the locations of locker compartments.

19. The method of claim 17, wherein presenting the user with locations of locker compartments comprises displaying a list on the electronic device identifying the locations of locker compartments.

20. The method of claim 17, further comprising, if the number of rentals that the user wants to purchase is greater than one, receiving from the user an indication that the locations of the lockers to be rented is selected from the group consisting of a single currently selected location, multiple currently selected locations, and future selected locations.
